(19) United States
(12) Patent Application Publication
(10) Pub. No.: US 2024/0403949 A1
(43) Pub. Date: Dec. 5, 2024

(54) METHOD AND SYSTEM FOR ONLINE SCHEDULING AND SHIFT MANAGEMENT

(71) Applicant: TimeWeSp Inc., Bellevue, WA (US)

(72) Inventor: Kristian Andaker, Bellevue, WA (US)

(21) Appl. No.: 18/204,655

(22) Filed: Jun. 1, 2023

(51) Int. Cl. G06Q 30/08; G06Q 10/0631; G06Q 20/36

(52) U.S. Cl. CPC G06Q 30/08; G06Q 10/063116; G06Q 20/36

(57) ABSTRACT

Provided is a method and system for scheduling employees to a work shift based on the undesirability of one or more employees for the work shift. The method includes creating a rotation by a manager and assigning a predefined shift work credit value to each employee, sending a communication message corresponding to the rotation to the employees, allowing an employee to bid for a work shift to avoid being called on for the work shift based on the communication message, receiving the bid for the work shift from the employee, allowing another employee to sign up to take the work shift, rescheduling the work shifts of the employee bidding to avoid the work shift and the another employee desiring to accept that work shift, and adjusting the shift work credit value of the both the employees.

### TECHNICAL FIELD

The present invention relates generally to managing the work schedules of a plurality of employees, and more particularly, to a method and system for scheduling at least one of a plurality of employees to a work shift based on undesirability for the work shift.

### BACKGROUND

Managing and scheduling a large workforce of employees has been a painstaking and intricate task in traditional systems and methods. The larger the organization, the more difficult it can be to efficiently manage employee resources, such as assigning shifts, managing vacation time, communicating with staff, and other related tasks. In many work environments, certain tasks require consistent staffing during specific time windows, sometimes 24/7 throughout the year. A team of employees is collectively responsible for performing these tasks, which necessitates meticulous scheduling to ensure that there is always adequate staff coverage. However, manual scheduling or using existing tools to manage this process can be very labor-intensive. Managers often end up having to ask for volunteers to cover shifts due to unexpected events such as employee vacations, temporary leaves, hiring, and departures. Unfortunately, most current scheduling systems lack transparency and clear rules, leading to employee dissatisfaction.

Additionally, prior systems fail to give employees any control over the scheduling process, such as allowing them to input their personal scheduling preferences. As a result, employees often feel that scheduling decisions are not fair, with holiday shifts being a common point of contention. Moreover, most scheduling systems lack predictability, as they do not provide sufficient notice of future schedules, causing employees to have difficulty planning their leaves. These shortcomings of existing scheduling systems lead to reduced productivity and high staff turnover.

The predominant method of shift scheduling involves a manager manually recording employees' names for each shift while attempting to account for various work restrictions and accommodating staff feedback by frequently changing the shift assignments. However, this manual approach to solving scheduling problems is not effective.

To address the scenario discussed above, U.S. Ser. No. 11/551,168B1 discloses a service provider that may use a shift schedule and the location of an employee's mobile device to determine if they will arrive on time for a scheduled shift. If the employee is unlikely to arrive on time, the service provider may find a replacement employee within a certain distance of the business. Additionally, if the business is overstaffed, the service provider may offer an employee an incentive to leave work early.

Further, U.S. Ser. No. 11/488,078B2 discloses a time slot scheduling system where employees are separated into bid groups. A bidding session is created with a specific time window for employees in the group(s) to enter their preferred time slots, and another time window for employees to select their preferred time slots from the available ones in the bidding session.

Currently, none of the existing systems and methods can provide an improved shift management system that can provide employees control over the scheduling process and model the shift assignment as a communal activity among staff according to explicit rules.

Although shift management methods and systems are proposed in the past, they have their own shortcomings or limitations, thus there still exists a need for a more reliable solution that can provide employees control over the scheduling process. Accordingly, the proposed is a method and system for scheduling at least one of a plurality of employees to a work shift that is undesirable to one or more employees.

### SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only and is not intended to limit the scope of the present disclosure.

In an embodiment, the present invention provides system and method for scheduling at least one employee of one or more employees to a work shift that is undesirable to one or more employees. The method includes creating a rotation by a manager via an admin user interface, wherein the rotation comprises one or more employees as a part of a staff group, work shifts, and a rotation period. Further, each employee of the one or more employees is assigned a predefined shift work credit value and the predefined shift work credit value is added to a corresponding credit wallet balance associated with each employee of the one or more employees, wherein total credit for the staff group remains constant. Further, the method includes allowing a first employee of the one or more employees to bid for avoiding a work shift via an employee user interface, wherein the bid comprises a bid credit value, wherein the bid credit value is a part of the credit wallet balance. Further, the method includes receiving the bid for avoiding the work shift from the first employee and the one or more employees. Further, the method includes allowing a second employee of the one or more employees to sign up via the employee user interface to take the bid work shift before auto-allocation. Further, the method includes determining whether the second employee or the one or more employees self-assign the bid work shift before auto-allocation. Further, the method includes one of assigning the bid work shift to the second employee if the second employee self-assigned the bid work shift, or auto assigning the bid work shift to the one or more employees based on an auto-allocation technique if no self-assignment occurs. Further, the method includes rescheduling the work shifts of the first employee, and the second employee or the employee assigned with the auto allocated bid work shift. Further, the method includes adjusting the credit wallet balance of the first employee, and the second employee or the employee assigned with the auto allocated bid work shift.

In an embodiment, the method further includes sending a communication message to the one or more employee on creation of the rotation and allowing the one or more employee to open the employee user interface via a hyperlink in the communication message., wherein the communication message comprises at least an email, a short message service (SMS), a push message, or a text message.

In an embodiment, the predefined shift work credit value is the same for all the employees. In another embodiment, the predefined shift work credit value is customizable by the manager.

In an embodiment, the second employee or the employee assigned with the auto allocated bid work shift receives the bid credit value from the first employee and the one or more employees, and a default credit value from each of the one or more employee of the staff group for a bid work shift assignment.

In an embodiment, the method of adjusting the credit wallet balance of the first employee comprising reducing the credit wallet balance of the first employee, wherein reduction value comprises a combination of the bid credit value of the first employee and the default credit value deducted from each of the one or more employees of the staff group for the bid work shift assignment.

In an embodiment, the method further comprising initiating an automatic shift allocation by the manager for a first time via the admin user interface after a threshold period lesser than the rotation period.

In an embodiment, the auto-allocation technique is based on an algorithm that selects the employee with the lowest score for credit wallet balance+bid credit value * Number of employees in the staff group/2.

In an embodiment, the method further comprising allowing the first employee to modify the previous bid after the auto-allocation.

In an embodiment, the method further comprising initiating a bidding process automatically in an emergency situation using the credit wallet balance of all the employees of the staff group, wherein the emergency situation comprises an employee is removed from the rotation, a block period is added for the one or more employees, an employee left an organization. In the emergency situation, the system offers more credit value for assigning the shift in the communication messages to one or more employees.

In an embodiment, the method further comprising allowing exchange of a shift between two employees.

These and other features and advantages of the present invention will become apparent from the detailed description below, in light of the accompanying drawings.

### BRIEF DESCRIPTION OF THE DRAWINGS

FIG. 1 illustrates a computing environment or general implementation for scheduling at least one employee of one or more employees to a work shift that is undesirable to one or more employees, according to an exemplary embodiment of the present invention;

FIG. 2 is a block diagram illustrating a preferred architecture for scheduling at least one employee of one or more employees to a work shift that is undesirable to one or more employees, according to an embodiment of the present invention;

FIG. 3 illustrates an example admin user interface screen presented to a manager for creating a rotation, according to an embodiment of the present invention;

FIG. 4 illustrates the example admin user interface screen presented to the manager for entering details for creating the rotation, according to an embodiment of the present invention;

FIG. 5 illustrates an example user interface screen presented to one or more user on clicking a link in a communication message corresponding to the rotation, according to an embodiment of the present invention;

FIG. 6 illustrates an example employee user interface screen presented to a first employee or one or more employees to bid to avoid a work shift, according to an embodiment of the present invention;

FIG. 7 illustrates the example employee user interface screen presented to the first employee or the one or more employees displaying previous bids to avoid the work shifts, according to an embodiment of the present invention;

FIG. 8 illustrates an example employee user interface screen presented to a second employee or one or more employees for self-assigning the work shifts, according to an embodiment of the present invention;

FIG. 9 illustrates an example user interface screen where the manager can assign a work shift to an employee, according to an embodiment of the present invention;

FIG. 10 illustrates an example employee user interface screen displaying work shift assignments to the one or more employees after automatic shift allocation initiated by the manager, according to an embodiment of the present invention;

FIG. 11 illustrates an example employee user interface screen displaying shift work credit value for the one or more employees, according to an embodiment of the present invention;

FIG. 12 illustrates an example employee user interface screen of an activity log, according to an embodiment of the present invention;

FIG. 13 illustrates an example employee user interface screen presented to the one or more employees for exchanging a work shift, according to an embodiment of the present invention;

FIG. 14 illustrates an operational flow diagram of an exemplary method for exchanging the work shift between two employees, according to an embodiment of the present invention;

FIG. 15 illustrates a flow diagram of a method for scheduling at least one employee of the one or more employees to the work shift that is undesirable to the one or more employees, according to an exemplary embodiment of the present invention; and

FIG. 16 is a block diagram illustrating the computing device that hosts an employee shift management application, according to an exemplary embodiment of the present invention.

### DETAILED DESCRIPTION

As used in the specification, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. There may be additional components or processes described in the foregoing application that are not depicted on the described drawings. In the event, such a component or process is described, but not depicted in a drawing, the absence of such component and process from the drawings should not be considered as an omission of such design from the specification.

Before describing the present invention in detail, it should be observed that the present invention utilizes a combination of components or processes, which constitutes a system and method for scheduling at least one employee of one or more employees to a work shift that is undesirable to the one or more employees. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items. Further, the word “user” and “person” are used interchangeably in the description.

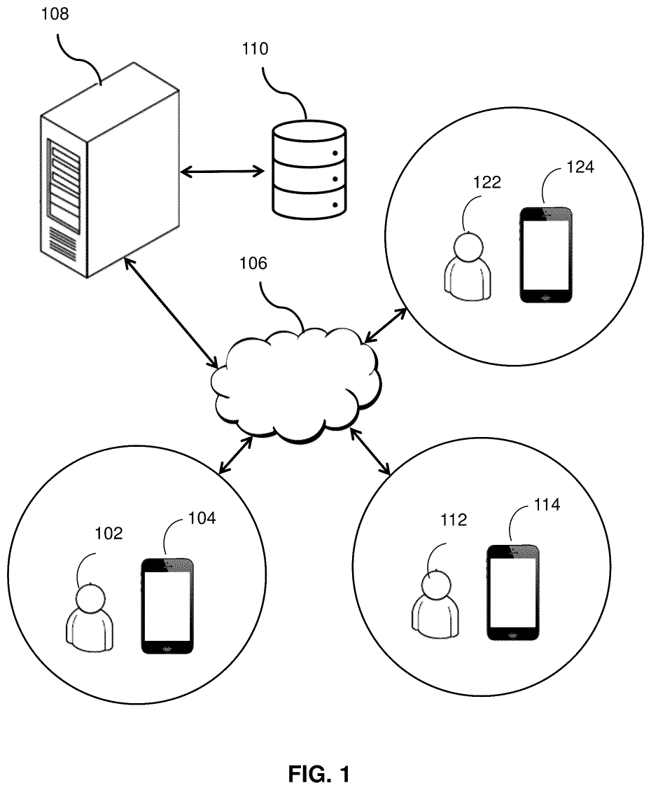

The system and method for scheduling at least one employee of one or more employees to a work shift that is undesirable to the one or more employees will now be described with reference to the accompanying drawings, particularly FIGS. 1-16.

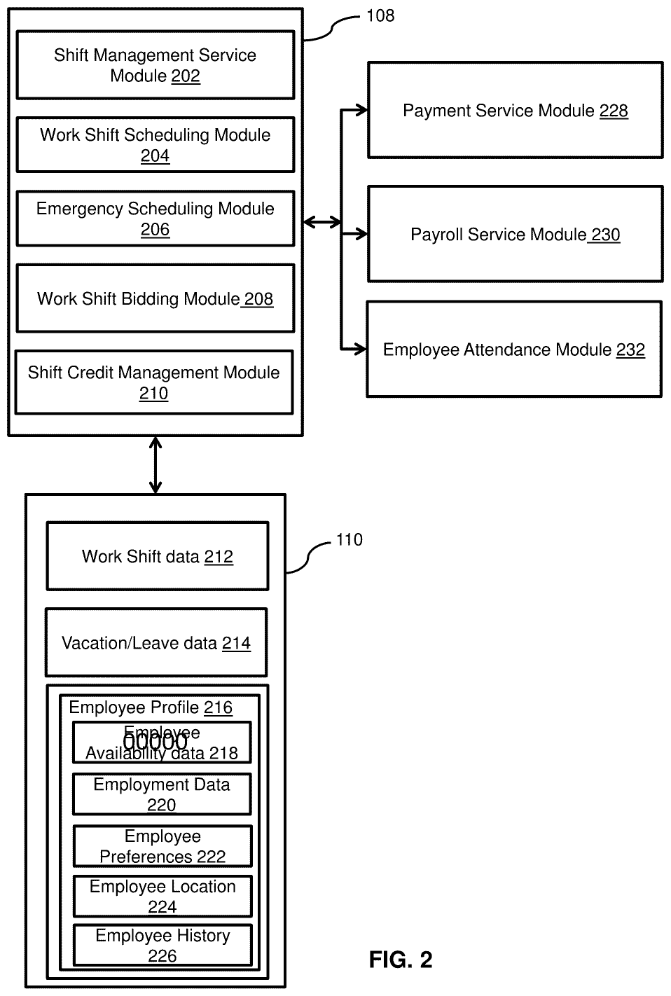

Referring to FIG. 1 in conjunction with FIGS. 2-16, a system 100 for scheduling at least one employee 102 of one or more employees to a work shift that is undesirable to the one or more employees is shown, in accordance with an exemplary embodiment of the present invention. The system 100 includes a server computing device 108 that hosts an employee shift management (hereinafter referred to as ESM) application. Different components of the server computing device 108 are disclosed in conjunction with FIG. 2.

In an embodiment, the ESM application is configured to fetch employee data related to one or more employees, for example, the first employee 102 from one or more data stores, for example, data store 110. In an embodiment, the data store 110 includes at least one of a database, a storage, an application, a plug-in, and cookies. In an example, the data store 110 is a cloud database. In another example, the data store 110 is a distributed storage. In an embodiment, the employee data includes at least one of work schedules, time entries, clock-in and clock-out times, available and consumed vacation time, overtime, skill sets, shift timing, employee group, number of times late for an assigned shift, reason for late coming, frequency of taking leave, shift work credit value associated with each employee, frequency of shortage of attendance, and absences.

In an embodiment, the ESM application is configured to present an admin user interface to a manager 112 to create a rotation. In an embodiment, the rotation includes one or more employees as a part of a staff group, work shifts, and a rotation period, and each employee of the one or more employees is assigned a predefined shift work credit value and the predefined shift work credit value is added to a corresponding credit wallet balance associated with each employee of the one or more employees, wherein total credit for the staff group remains constant. In an embodiment, the predefined shift work credit value is the same for all employees. In another embodiment, the predefined shift work credit value is customizable by the manager 112. For example, the predefined shift work credit value customizable by the manager 112 is based on one or more criteria. In an embodiment, the one or more criteria includes at least the amount of work shifts individual staff members/employees have recently worked, individual employee's leave pattern, individual employee's working shift patterns, and other scheduling solution that uses no credits.

As the manager 112 creates a rotation, the ESM application is configured to send a communication message corresponding to the rotation to the one or more employees. In an embodiment, the communication message includes at least an email, a short message service (SMS), a push message, or a text message. In an embodiment, the communication message includes a hyperlink to an employee user interface of the ESM application. The employee 102 or the one or more employees can open the employee user interface via the hyperlink in the communication message.

The one or more employees receive the communication message on communication devices, for example, a communication device 104,124 associated with them. In the context of the present invention, the communication device 104 refers to an electronic device that can be used to communicate over the communication network 106. Examples of the communication device 104 include but are not limited to a cell phone, a smart phone, a cellular phone, a cellular mobile phone, a personal digital assistant (PDA), a personal computer, a server, a cloud enabled devices, a laptop, a smart television, and a tablet computer. Examples of types of the communication network 106 include, but are not limited to a local area network, a wide area network, a radio network, a virtual private network, an internet area network, a metropolitan area network, a satellite network, Wi-Fi, Bluetooth Low energy, a wireless network, and a telecommunication network. Examples of the telecommunication network include but are not be limited to a global system for mobile communication (GSM) network, a general packet radio service (GPRS) network, third Generation Partnership Project (3GPP), 4G, Long-Term Evolution (LTE), an enhanced data GSM environment (EDGE) and a Universal Mobile Telecommunications System (UMTS).

After receiving the communication message from the ESM application, the employee 102 open the employee user interface to bid for a work shift to avoid being called on for the work shift. In an embodiment, the bid includes a bid credit value. The bid credit value is a part of the credit wallet balance. For example, the credit wallet balance of an employee X was 1.2 and the predefined shift work credit value for a rotation is assigned as 5 for the employee X. Hence, total credit wallet balance for the employee X is 6.2. Out of 6.2 credit balance, the employee X can spend a certain amount, for example, 1 credit for the bid. Further, the ESM application receives the bid for the work shift from the first employee 102 and from the one or more other employees. In an embodiment, the bids are entered as dates and times or date and time ranges.

In another embodiment, shifts are assigned automatically to the one or more employees if none of the employees take any action or responds to the communication message. The action/response comprises bidding for a shift or manually selecting a shift through the employee user interface.

Further, the ESM application is configured to allow a second employee 122 (with user communication device 124) of the one or more employees to sign up via the employee user interface to take the bid work shift before auto-allocation. In an embodiment, the ESM application is configured to determine whether the second employee 122 or the one or more employees self-assign the bid work shift before auto-allocation. Further, the ESM application is configured to assign the bid work shift to the second employee 122 if the second employee 122 has self-assigned the bid work shift. Otherwise, the ESM application is configured to auto assign the bid work shift to the one or more employees based on an auto-allocation technique if no self-assignment occurs.

In an embodiment, the auto-allocation technique is based on an algorithm that selects the employee with the lowest core for credit wallet balance+bid credit value * Number of employees in the staff group/2.

In an embodiment, the second employee 122 or the employee assigned with the auto allocated bid work shift receives the bid credit value from the first employee 102 and the one or more employees, and a default credit value from each of the one or more employee of the staff group for the bid work shift assignment. In an example, when the rotation is set up, employees A, B, C, X, Y, Z are each given a credit balance. Through previous shift assignments and bids, those balances will have changed. Consider, the credit balances they each have before the Christmas shift allocation are A: 2, B: 2.5, C: 5, X: −2.5, Y: 5, Z: 3. The Employees A and B have each entered bids of 1.0 to avoid working on Christmas. C has entered a bid of 2.1 to avoid working on Christmas. The employees X, Y, and Z can observe in the shift schedule that the Christmas shift is worth 4.1 credits more than the other shifts. The other shifts are worth 5 (E.g., =1 credit paid by default from each member other than the member who gets the shift). So, the Christmas shift is worth 9.1 credit. Further, employee Y clicks “take this shift” on Christmas before X or Z have the chance. The employee Y gets 1 credit from every other member, plus Y also gets the bid amounts from A, B, and C. The new credit balance would be A: 0, B: 0.5, C: 1.9, X: −3.5, Y: 14.1, Z: 2.

In another example, if nobody clicks “take this shift” for Christmas before the system gets to auto-allocation, the system will use the auto-allocation algorithm to determine who should get the shift. The system looks at who has the least credits, but even if someone has the least credits, they are unlikely to get the shift if they have bid to avoid the shift. Considering the above example, the employee X would be auto-assigned the shift because he/she has the least credits, and he/she didn't bid to avoid the shift. New credit balances would be: A: 0, B: 0.5, C: 1.9, X: 6.6, Y: 4, Z: 2.

In another embodiment, the method of allowing the second employee 122 of the one or more employees to sign up to take the work shift further includes entering a bid by the second employee 122 to take the work shift. In an embodiment, the ESM application is configured to assign the work shift to the second employee 122 or the one or more other employees based on a bid matching technique if the second employee 122 bids to take the shift.

In an example, the bid matching technique in the algorithm compares the bids for avoiding the work shift with the bids for accepting the work shift. In an embodiment, the employees that bid more to avoid the work shift may win the bid to avoid the work shift and the employees that bid more to take the work shift may win the bid to take the work shift. In another embodiment, the employees that bid more to avoid the work shift may win the bid to avoid the work shift and the employees that bid less to take the work shift may win the bid to take the work shift. In yet another embodiment, the employees that bid more to avoid the work shift may win the bid to avoid the work shift and all other employees that bid to take the work shift may get a particular amount of the shift work credit value to take the work shift. In yet another embodiment, the employees that bid less to avoid the work shift may win the bid to avoid the work shift and the employees that bid more to take the work shift may win the bid to take the work shift. In yet another embodiment, the employees that bid less to avoid the work shift may win the bid to avoid the work shift and the employees that bid less to take the work shift may win the bid to take the work shift.

Further, the ESM application is configured to reschedule the work shifts of the first employee 102, and the second employee 122 or the employee assigned with the auto allocated bid work shift. After rescheduling the work shifts, the ESM application is configured to adjust the credit wallet balance of the first employee 102, and the second employee 122 or the employee assigned with the auto allocated bid work shift.

In an embodiment, the method of adjusting the credit wallet balance of the first employee 102 comprising reducing the credit wallet balance of the first employee 102, wherein reduction value includes a combination of the bid credit value of the first employee 102 and the default credit value deducted from each of the one or more employees of the staff group for the bid work shift assignment.

In another embodiment, the method of adjusting the credit wallet balance of the second employee 122 or the employee assigned with the auto-allocated bid work shift comprising increasing the credit wallet balance of the second employee 122 or the employee assigned with the auto allocated bid work shift, wherein increment value comprises a combination of the bid credit value of the first employee 102, and the one or more employees and the default credit value deducted from each of the one or more employee of the staff group for the bid work shift assignment.

In an embodiment, the ESM application allows the manager 112 to initiate an automatic shift allocation for a first time via the admin user interface after a threshold period, lesser than the rotation period, when the one or more employees have entered bids and one or more employees have manually selected the preferred future shifts. Subsequently, the ESM application initiates the automatic shift allocation periodically.

In an embodiment, the automatic shift allocation for the employee is based on one or more criteria, wherein the one or more criteria includes but not limited to employee's shift work credit balance, and the bids value to avoid shifts. In an embodiment, the ESM application allows the first employee 102 to modify the previous bid after the automatic shift allocation.

In an embodiment, the ESM application is configured to initiate a bidding process automatically in an emergency situation using the credit wallet balance of all the employees of the staff group, wherein the emergency situation comprises an employee is removed from the rotation, a block period is added for the one or more employees, an employee left an organization. In the emergency situation, the system offers more credit value for assigning the shift in the communication messages to one or more employees.

In an embodiment, the ESM application is configured to allow exchange of a shift between two employees. In an example, there are two different scenarios for get out of working a shift which a person has already been assigned. The first one is if the shift is far enough into the future (i.e. more than the rotation period), then the employees can simply vacate the shift. They'll give the credit value of the shift back to the other users. The second scenario is if the shift is closer in time (i.e., less than the rotation period, for example, 6 months), they cannot vacate the shift on their own. They must find someone else to take it over. In one case, they can offer the shift up for exchange. When they do this, they can also “bid” a little extra for someone to want to take it over. In another case, they can enter an exchange/swap between the shift they want to get rid of, and another shift which someone else has “offered for exchange”. If they do, the other person will get an email asking them to approve the exchange/swap.

FIG. 2 is a block diagram 200 illustrating a preferred architecture for scheduling at least one employee of the one or more employees to the work shift that is undesirable to one or more employees, according to an embodiment of the present invention. The server computing device 108 may include a shift management service module 202 that may interact with the manager device 114 and/or the employee device 104,124 to provide the shift management service. The shift management service module 202 may have access to and maintain manager profile and employee profile 216. The shift management service module 202 helps the manager 112 to manage employee work schedules and shift assignments. The shift management service module 202 typically includes features such as scheduling templates, shift swapping, time-off requests, and automatic shift assignments based on employee availability and qualifications. It may also include tools for communicating with employees about schedule changes or updates, such as text messages or email notifications. Using the shift management service module 202, the manager 112 is able to streamline the scheduling process and reduce the administrative burden of managing work schedules. It can also improve employee satisfaction and reduce scheduling conflicts by allowing employees to view their schedules in advance and request time off or swap shifts with other employees. Further, the shift management service module 202 may also include analytics and reporting features, which can provide insights into workforce scheduling patterns and help for better shift assignments.

Further, the server computing device 108 may include a work shift scheduling module 204. The work shift scheduling module 204 may be loaded into memory and executed by a processor of the server computing device 108 to perform one or more methods and processes for scheduling work shifts. In an embodiment, the work shift scheduling module 204 is configured to present the admin user interface to the manager 112 for creating the rotation. Further, the work shift scheduling module 204 is configured to present the employee user interface to one or more employees for accepting the bidding for the work shifts that are undesirable to one or more employees. Further, the work shift scheduling module 204 is configured to allow the manager 112 to initiate the automatic shift allocation.

Further, the server computing device 108 may include an emergency scheduling module 206. This module helps the manager 112 to create employee work schedules quickly and efficiently in response to unexpected events or emergencies. The emergency scheduling module 206 typically includes features such as automatic shift assignments, real-time updates, and communication tools to ensure that employees are notified of schedule changes and can quickly respond to the emergency. Using an emergency scheduling module 206 can help managers to respond to unexpected events such as sudden increases in demand, staff shortages, employee exit from the current organization, death of an employee, accidents, or natural disasters. The module 206 can help to ensure that the business has the appropriate number of employees on hand to meet demand and can quickly adapt to changing circumstances.

In an alternate embodiment, the server computing device 108 may include a work shift bidding module 208. The work shift bidding module 208 allows one or more employees to bid for the work shift to avoid being called on for the work shift via the employee user interface. Similarly, this module allows the one or more employees to bid for taking the work shift. In an embodiment, the work shift bidding module 208 includes the bid matching algorithm. The bid matching technique in the algorithm compares the bids for avoiding the work shift with the bids for accepting the work shift. In an embodiment, the employees that bid more to avoid the work shift may win the bid to avoid the work shift and the employees that bid more to take the work shift may win the bid to take the work shift. In another embodiment, the employees that bid more to avoid the work shift may win the bid to avoid the work shift and the employees that bid less to take the work shift may win the bid to take the work shift. In yet another embodiment, the employees that bid more to avoid the work shift may win the bid to avoid the work shift and all other employees that bid to take the work shift may get a particular amount of the shift work credit value to take the work shift. In yet another embodiment, the employees that bid less to avoid the work shift may win the bid to avoid the work shift and the employees that bid more to take the work shift may win the bid to take the work shift. In yet another embodiment, the employees that bid less to avoid the work shift may win the bid to avoid the work shift and the employees that bid less to take the work shift may win the bid to take the work shift.

Further, the server computing device 108 may include a shift credit management module 210. This module is configured to manage the shift work credit value for the one or more employees. The shift credit management module 210 typically includes features such as the ability to track employee shift credits or hours, allocate shift credits to specific employees or groups, and provide real-time updates on available shift credits or hours. Using the shift credit management module 210 can help employers to ensure that employees are compensated appropriately for the hours they work and can help to prevent scheduling conflicts or misunderstandings related to shift credits or hours. Some shift credit management modules may include advanced features such as the ability to track and analyze employee credit redemption patterns or the ability to adjust credit allocation based on changing business needs or priorities.

Further, the server computing device 108 may interact with one mor more remote modules, for example, a payment service module 228, a payroll service module 230, and an employee attendance module 232. The payment service module 228 is designed to handle payments related to employee work shifts. The payment service module 228 typically includes features such as payment processing, invoicing, and reporting. Employers can use this module to calculate and process employee payments based on factors such as the number of hours worked, the type of shift worked, or the employee's rate of pay. The module can also generate invoices and reports to help employers track and manage payments and expenses related to employee work shifts. Using the payment service module 228 can help employers to streamline and automate the payment process, reducing the risk of errors or delays. The module can also help to ensure that employees are paid accurately and on time, improving employee satisfaction and retention.

The payroll service module 230 is designed to help employers manage and process employee payroll. The payroll service module typically includes features such as payroll processing, tax calculations, and reporting. Employers can use this module to calculate and process employee payments based on factors such as the number of hours worked, the type of shift worked, or the employee's rate of pay. The module can also generate tax forms and reports to help employers comply with local, state, and federal regulations.

Further, the employee attendance module 232 is used by organizations to keep track of employee attendance and time worked. It allows HR personnel and managers to record, monitor, and manage employee attendance data in a systematic and efficient way. The module can be integrated with the organization's existing HR management system or used as a standalone application. Typically, it provides features such as clock-in and clock-out tracking, time-off requests and approvals, automated notifications, and reporting capabilities. All these above modules (i.e., the payment service module 228, the payroll service module 230, and the employee attendance module 232) interact with different modules of the server computing device 108 for scheduling at least one of a plurality of employees to one or more work shift that are undesirable to one or more employees.

Additionally, the server computing device 108 collects data from the data store 110 as shown in FIG. 2. In an embodiment, the data store 110 stores work shift data 212, vacation/leave data 214, and employee profile 216. In an example, the work shift data 212 refers to the information related to the schedule of employees and their assigned work shifts. This data includes the start time, end time, duration, and break times for each shift. It also includes information about the employees assigned to each shift, such as their names, job titles, and any special requirements or accommodations they may have.

In an example, the vacation/leave data 214 for employees refers to the information related to the time off an employee has taken, including vacation days, sick days, personal days, and other types of leave. This data includes the start and end date of each leave period, the reason for the leave, and the number of days or hours taken.

As shown in FIG. 2, the employee profile 216 includes employee availability data 218. Employee availability data 218 for a work shift refers to information that indicates whether an employee is available to work during a particular shift or not. This information is typically based on factors such as an employee's schedule, personal commitments, and other obligations. Further, employee availability data 218 may be collected through various means, such as through employee self-reporting, a scheduling software system, or through communication with a supervisor. This data can be stored and accessed through various digital platforms, such as scheduling software or employee management systems, and can be used to streamline scheduling processes and improve overall workforce management.

Further, as shown in FIG. 2, the employee profile 216 includes employment data 220. Employment data 220 of an employee 102 refers to information related to their job, such as their job title, job description, work experience, skills, qualifications, and current employment status. This data helps the ESM application to determine which employees are best suited for particular shifts based on their abilities, experience, and availability. Further, current employment status provides an indication of the employee's exit date from an organization and future empty shifts which are previously assigned to the employee.

Furthermore, as shown in FIG. 2, the employee profile 216 includes employee preferences 222. Employee preference for a work shift refers to an employee's desired or preferred work schedule, including the days of the week, hours of the day, and frequency of shifts. Employees may have different preferences based on their personal and professional commitments, such as childcare, education, or other employment. Understanding employee preferences 222 is important for the ESM application to create a work schedule that accommodates the needs of his/her employees. This can lead to increased job satisfaction, motivation, and employee retention. When employees are able to work the shifts they prefer, they may be more productive and engaged on the job.

Furthermore, in some cases, the employee profile 216 includes employee location data 224. Employee location data 224 for a work shift refers to information about where an employee is physically located when they are scheduled to work a particular shift. This data can be used by the ESM application to ensure that employees are able to arrive at work on time and have enough staff to cover necessary shifts. By collecting and analysing employee location data 224, the ESM application can determine potential scheduling conflicts, such as an employee who lives far away from the workplace and may have difficulty arriving on time, or an employee who has transportation issues that may affect their ability to attend work. The ESM application can use this information to make decisions about shift scheduling, such as assigning employees who live nearby to early morning shifts or adjusting schedules to accommodate transportation or commute time.

Additionally, the employee profile 216 may include employee history 226. For example, the employee history 226 may provide information regarding the employee's attendance record at a past employer, performance history at a past employer, and so forth.

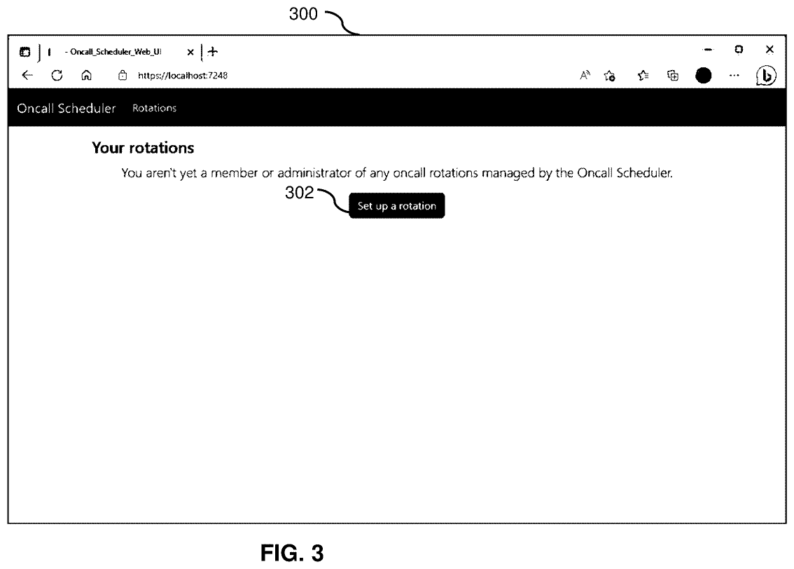

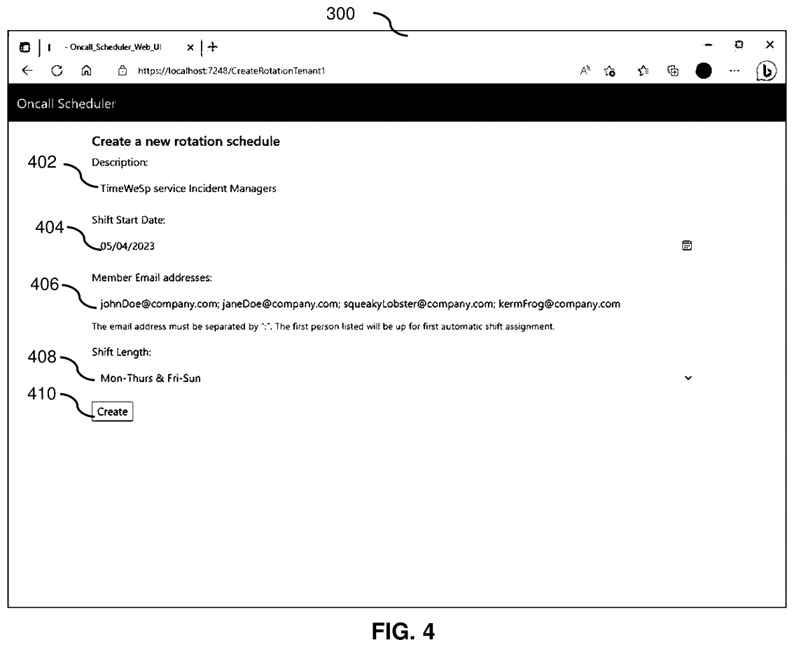

FIG. 3 illustrates an example admin user interface screen 300 presented to the manager 112 for creating the rotation, according to an embodiment of the present invention. As shown in FIG. 3, the manager 112 can click a web button, for example web button “set up a rotation” 302 related to creating the rotation. When the manager 112 clicks the web button 302, the admin user interface screen 300 displays one or more data input fields as shown in FIG. 4.

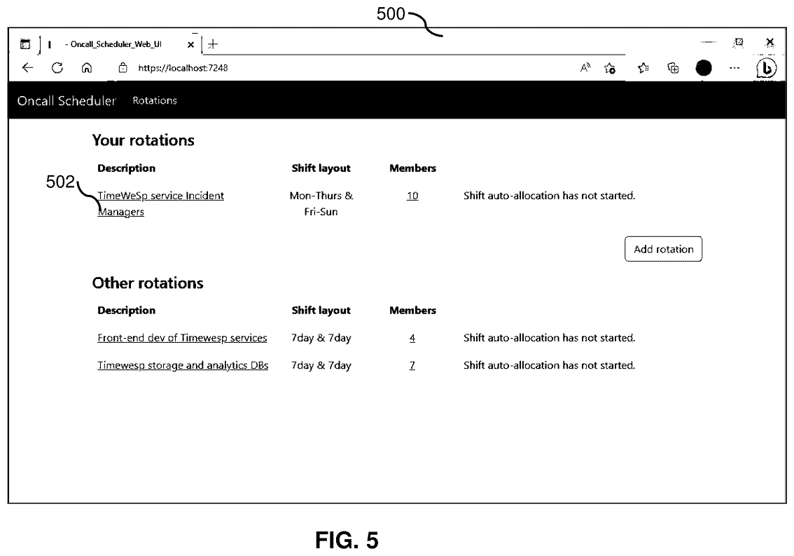

FIG. 4 illustrates the example admin user interface screen 300 presented to the manager 112 for entering details for creating the rotation, according to an embodiment of the present invention. The manager can enter a name for the rotation in a text input box 402. Further, the manager 112 can enter a start date of the rotation in a date input field 404. In an example, the manager 112 can enter the start date of the rotation in a calendar application that is displayed while entering the date in the date input field 404. The manager can enter an email address of one or more employees in a mail input field 406. The manager can enter shift length by selecting an option from a drop-down menu 408. After entering the required data in the respective data input fields, the manager 112 can click the create button 410 to create the rotation. In an embodiment, the rotation includes one or more employees as a part of a staff group and work shifts, and each employee of the one or more employees is assigned a predefined shift work credit value. The one or more employee as the part of the staff group are the employees whose email addresses are entered by the manager 112 in the mail input field 406. When the rotation is created, the one or more employees receive the communication message in their email addresses. Employees can click a hyperlink in the communication message to view and interact with the user interface screen. An example user interface screen is disclosed in conjunction with FIG. 5.

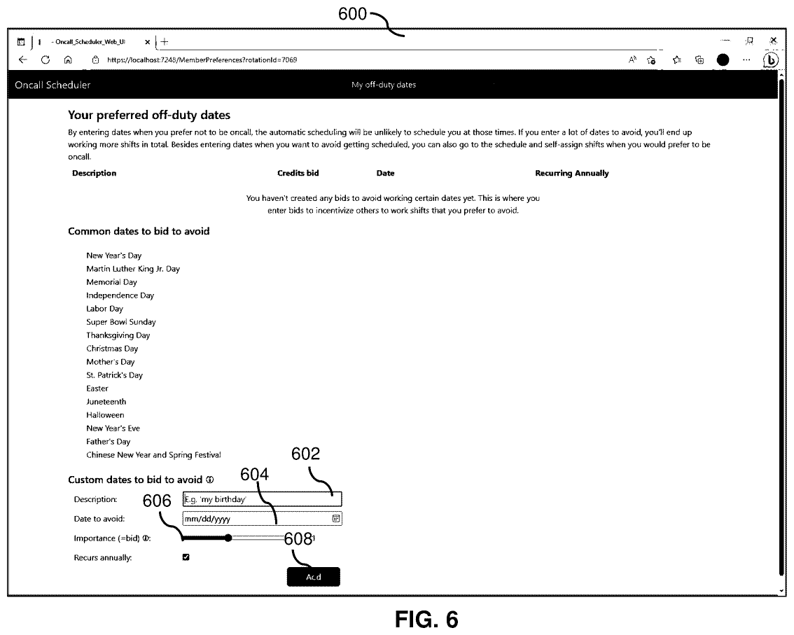

FIG. 5 illustrates the example user interface screen 500 presented to one or more user on clicking the hyperlink in the communication message corresponding to the rotation, according to an embodiment of the present invention. The employee, for example, employee 102 can click the hyperlink 502 to check his/her work schedules. When the employee clicks the hyperlink 502, the ESM application is configured to display the employee user interface screen that is disclosed in conjunction with FIG. 6.

FIG. 6 illustrates an example employee user interface screen 600 presented to the first employee 102 or to the one or more employees to bid to avoid the work shift, according to an embodiment of the present invention. The first employee 102 can enter/choose the date in the date field 602 on which he/she wants to avoid the work shift. The first employee 102 can enter a description related to that date (for example, birthday) in a text input field 604. Further, the first employee 102 can select the bid credit value by sliding the credit slider 606 for bidding to avoid the shift on the date entered by him/her in the date field 602.

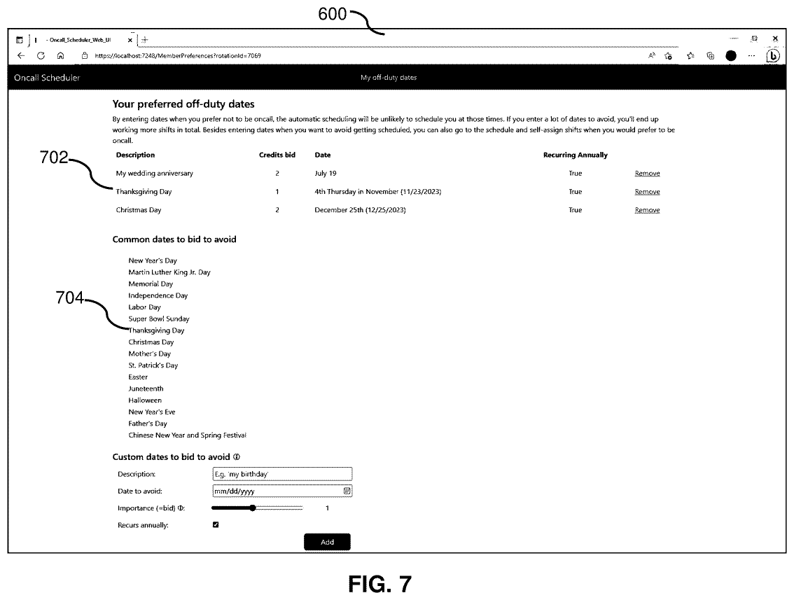

After selecting the bid credit value, the first employee 102 clicks on the add button 608 to participate in the bidding process related to avoiding one or more work shifts. In an embodiment, the bid includes the bid credit value, wherein the bid credit value is a part of the credit wallet balance. The first employee 102 can check one or more previous bids for the work shifts in the employee user interface screen as shown in FIG. 7.

FIG. 7 illustrates the example employee user interface screen 600 presented to the first employee 102 or the one or more employees displaying previous bids for the work shifts, according to an embodiment of the present invention. The employee user interface screen 600 displays the one or more previous bids for the work shifts in a section 702 as shown in FIG. 7. The first employee 102 or any other employee can check his future shifts and work shift avoidance request on the employee user interface screen 600. Further, the first employee 102 or any other employee can select common dates as shown in the section 704 to bid to avoid the shift on that date.

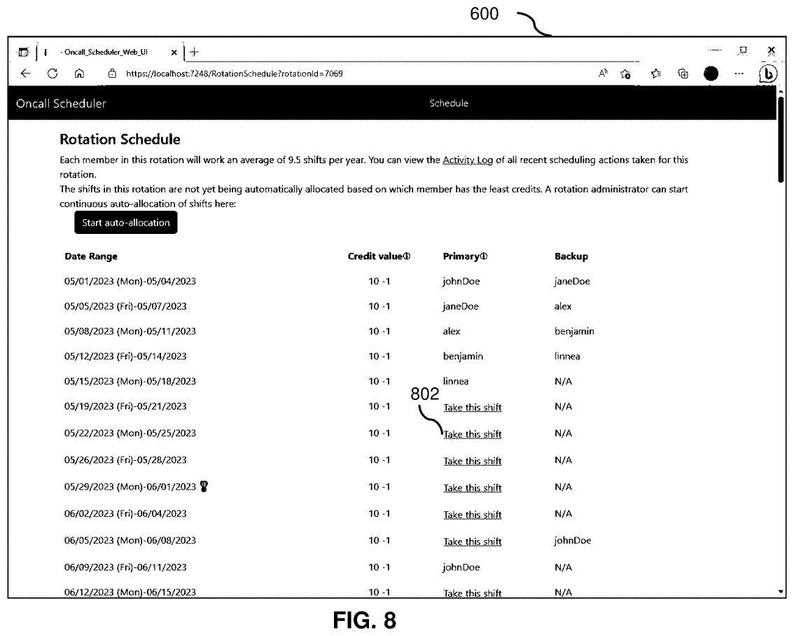

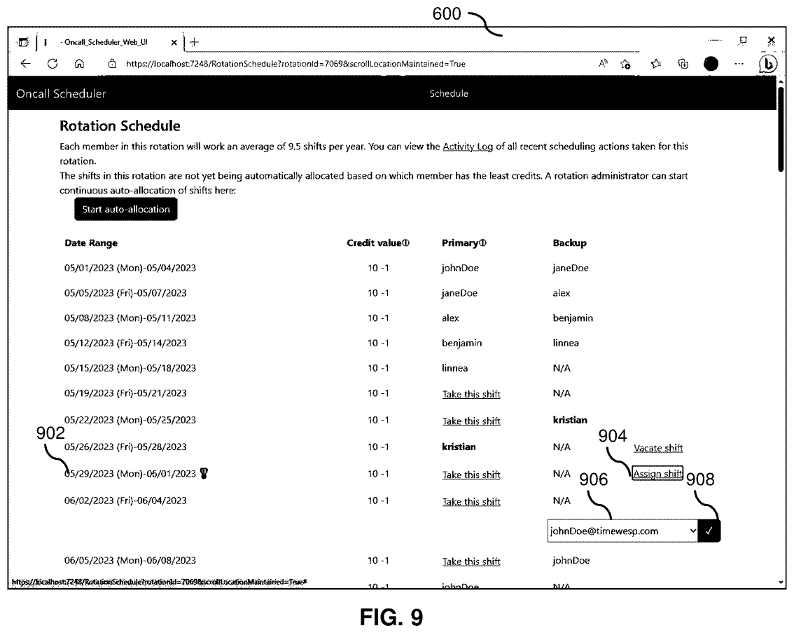

FIG. 8 illustrates the example employee user interface screen 600 presented to the second employee 122 or the one or more employees for self-assigning the work shifts, according to an embodiment of the present invention. As shown in FIG. 8, the second employee 122 can click “take this shift” hyperlink 802 to self-assign the work shift. In an embodiment, the second employee 122 can self-assign multiple work shifts by clicking the respective hyperlinks. Similarly, the manager can assign a work shift to an employee that is disclosed in conjunction with FIG. 9.

FIG. 9 illustrates the example user interface screen 600 where the manager 112 can assign the work shift 902 to an employee, according to an embodiment of the present invention. As shown in FIG. 9, the manager 112 can clicks on “assign shift” hyperlink 904 to assign the work shift 902. When the manager 112 clicks the “assign shift” hyperlink 904, an email input field corresponding to work shift 902 will be opened. For illustration purpose, the email input field 906 is opened where the manager 112 can enter the email address of the employee.

After entering the email address of the employee, the manager 112 can click an “assign” button or any web button 908 for assigning the work shift 902 to the employee. In an embodiment, the automatic shift allocation is initiated by the manager 112 via the admin user interface 300 after the threshold period when the one or more employees have entered bids and one or more employees have manually selected the preferred future shifts by clicking a web button “Shift auto-allocation” 910. In an embodiment, the automatic shift allocation for the employee is based on the algorithm that selects the employee with the lowest score for credit wallet balance+bid credit value * Number of employees in the staff group/2.

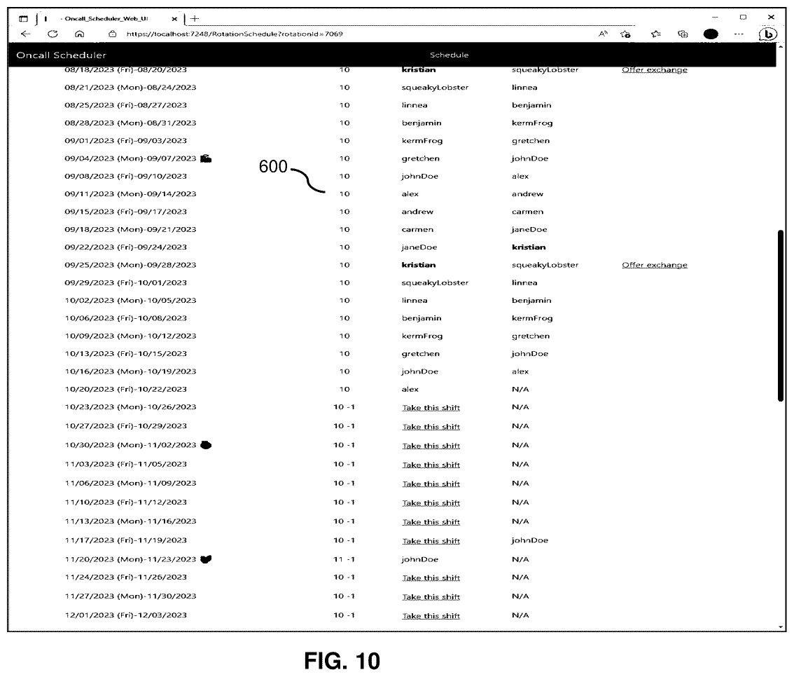

FIG. 10 illustrates an example employee user interface screen 600 displaying work shift assignments to the one or more employees after automatic shift allocation initiated by the manager 112, according to an embodiment of the present invention.

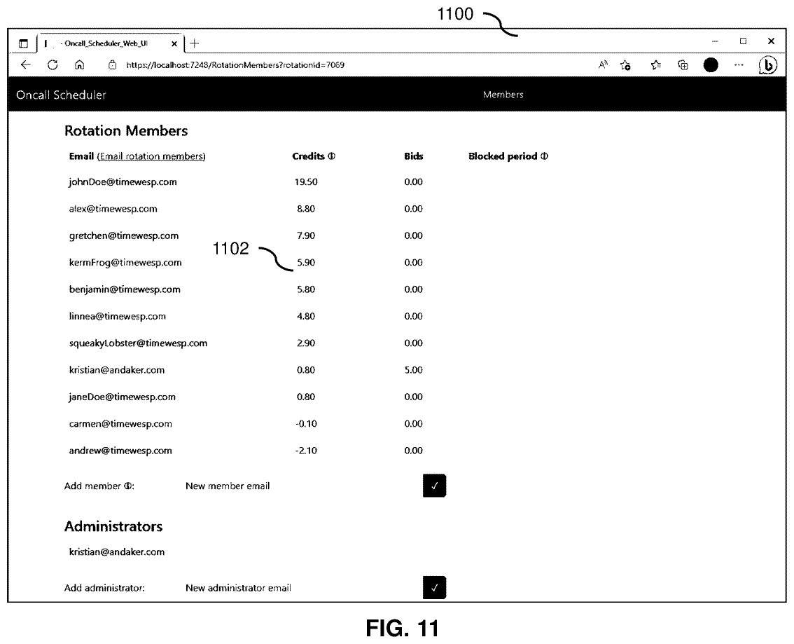

FIG. 11 illustrates an example employee user interface screen 1100 displaying shift work credit value for the one or more employees, according to an embodiment of the present invention. The manager 112 can change add or subtract an amount from the shift work credit value displayed in section 1102 of the example employee user interface screen 1100. One employee can check the shift work credit value of another employee. Thus, providing a transparent system for all the employee to cross check the shift work credit value.

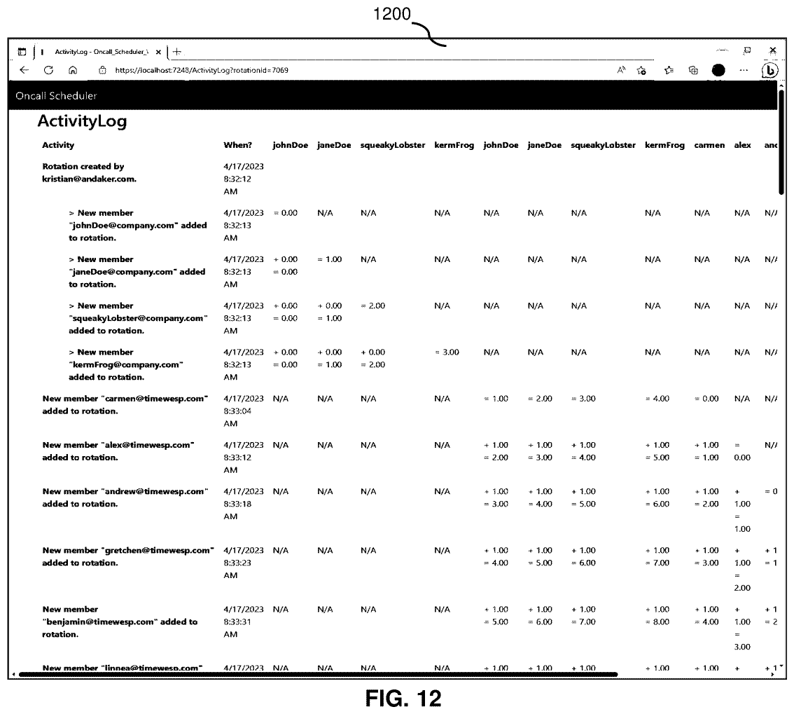

FIG. 12 illustrates an example employee user interface screen 1200 of an activity log, according to an embodiment of the present invention. In an embodiment, all the activities related to an employee are captured in the activity log. In another embodiment, all the activities related to one or more employees are captured in the activity log.

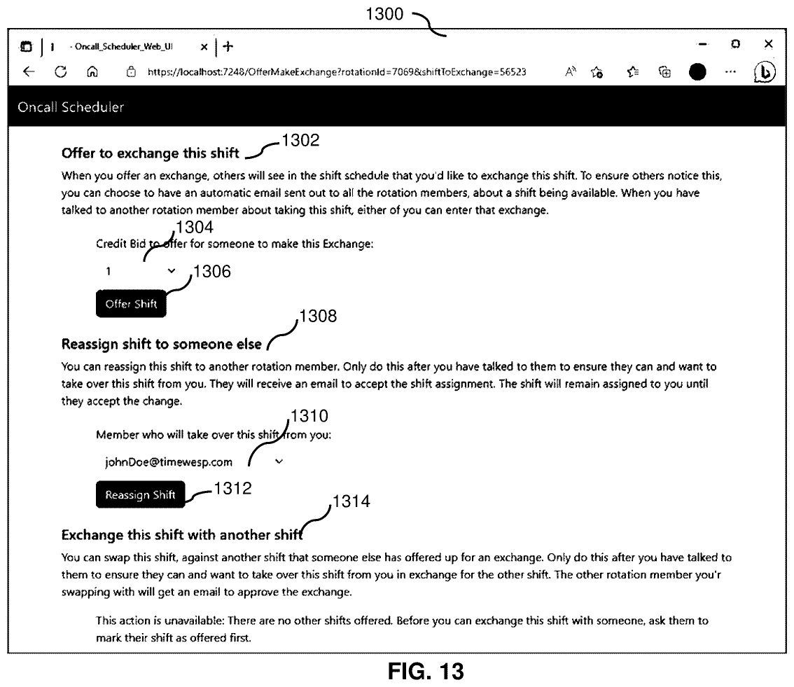

FIG. 13 illustrates an example employee user interface screen 1300 presented to the one or more employees for exchanging a work shift, according to an embodiment of the present invention. As shown in section 1302, one employee, for example, employee 102 can offer shift work credit value 1304 to another employee to exchange the shift. Then click the “offer shift” button 1316. Further, as shown in section 1308, one employee, for example, employee 102 can reassign the shift to another employee. To reassign the shift to another employee, employee 102 can enter the email id of the employee in the email input field 1310 and then click on “Reassign Shift” button 1312. Further, as shown in section 1314, one employee, for example, employee 102 can exchange the shift against another shift with the second employee 122.

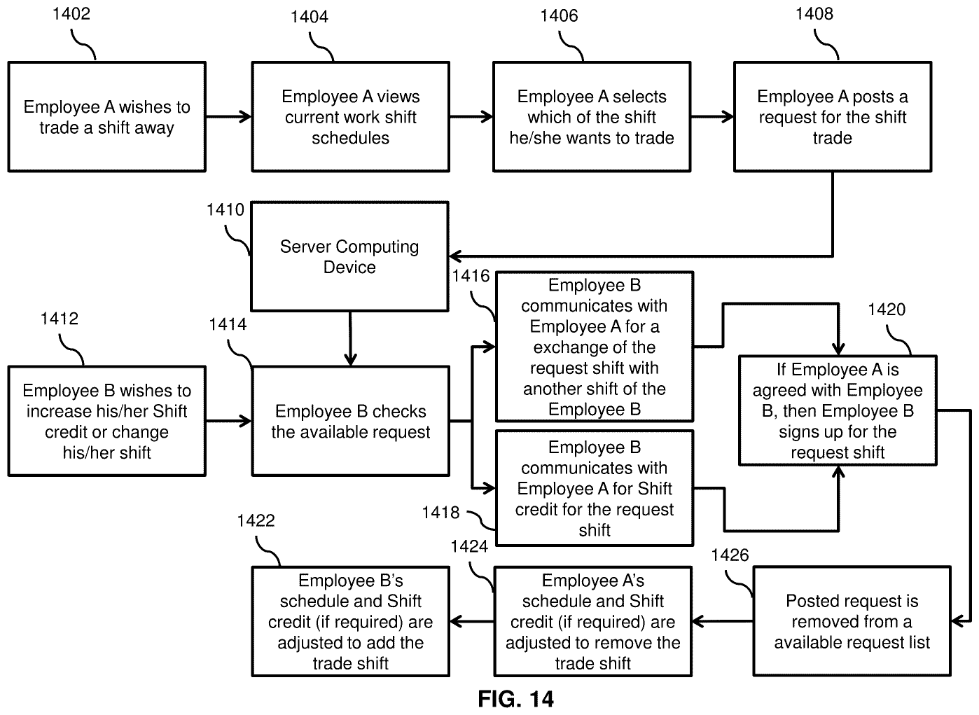

Turning to FIG. 14, an operational flow diagram of an exemplary method for exchanging the work shift between two employees, for example employee A and employee B, according to an embodiment of the present invention. Exchanging the work shift/shift trades comprises an exchange of shifts between at least one employee scheduled to work a particular shift and at least one employee scheduled not to work that particular shift.

At block 1402, an employee, for example, “employee A” desiring to trade a shift. Next, at block 1404, the employee A views his/her current schedule. Thereafter, at block 1406, the employee A selects which of the shift he/she wishes to trade. After selecting at least one shift, the employee A, at a block 1408, posts a request for exchanging the shift. Stated another way, the system provides the employee an opportunity to post a request for exchanging the shift.

At block 1410, the server computing device receives the request from the employee A and officially posts the shift, thereby making the shift available to other employees. In response, another employee, for example, “employee B” may respond to the shift trade request, block 1412. At block 1414, the employee B views the shift trade posts. Next, the employee B communicates with the employee A for an exchange of the request shift with another shift of the employee B, at block 1416. In another case, the employee B communicates with the employee A for shift work credit for the request shift, at block 1418.

At block 1420, if the communication between the two employees is successful that is the employee A is agreed with the terms and conditions of the employee B, then the employee B signs up for the request shift. After the employee B accepts the shift, the system updates the schedule data in the database, block 1422, to remove the shift trade request from the posted shifts. At block 1424, the operation adjusts the posting employee's schedule (i.e., employee A's schedule) to account for the executed shift trade by the responding employee (i.e., employee B). Likewise, at block 1426, the operation adjusts the responding employee's schedule (i.e., employee B's schedule) to reflect the change in schedule.

This completes the discussion of one illustrative method of operation for the shift trade software sub-module. It is anticipated that one of the ordinary skill in the art could devise alternative methods for modifying a shift, all of which would be encompassed by the present invention's ability to post-shift trade requests in an employee scheduling context.

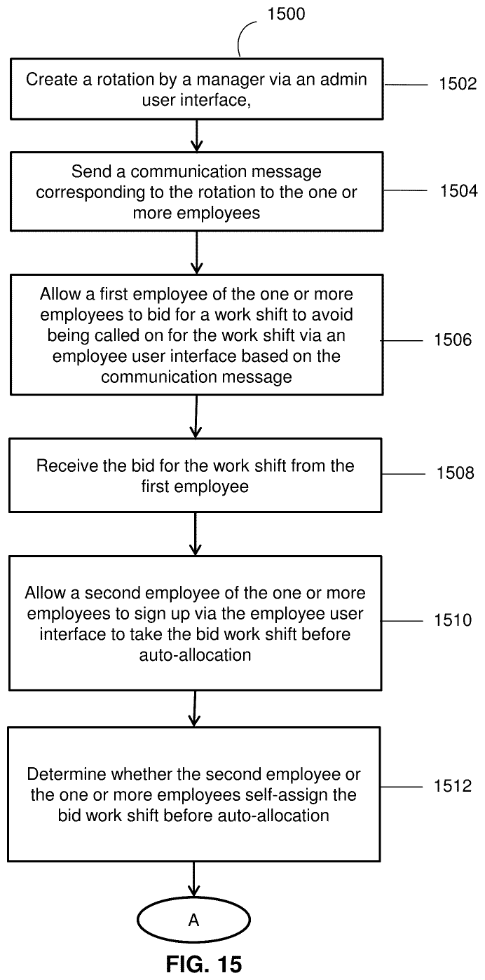

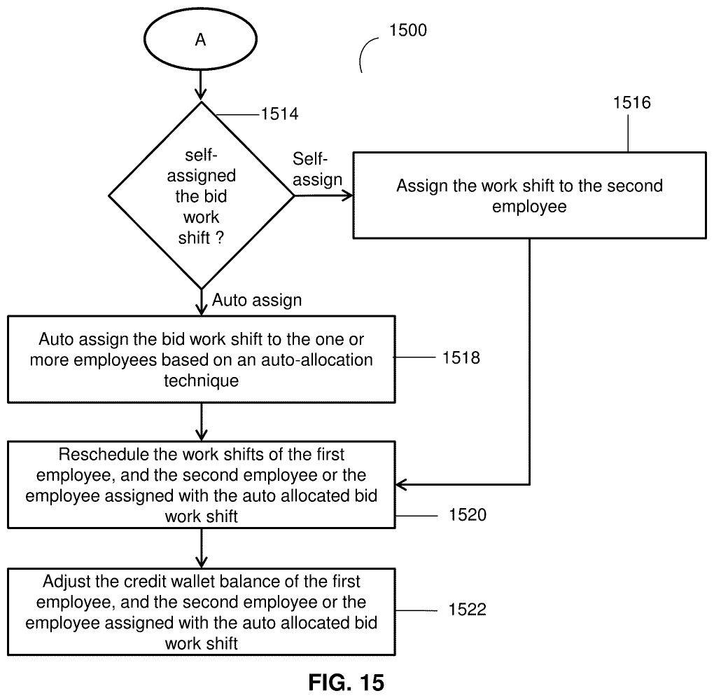

FIG. 15 illustrates a flow diagram 1500 of a method for scheduling at least the one employee 102 of the one or more employees to the work shift that is undesirable to the one or more employees, according to an exemplary embodiment of the present invention. At step 1502, the method includes creating the rotation by the manager 112 via the admin user interface, wherein the rotation comprises the one or more employees as a part of the staff group, the work shifts and the rotation period, wherein each employee of the one or more employees is assigned the predefined shift work credit value and the predefined shift work credit value is added to a corresponding credit wallet balance associated with each employee of the one or more employees, wherein total credit for the staff group remains constant. The method allows the ESM application to provide the admin user interface to the manager 112 for creating the rotation.

At step 1504, the method includes sending the communication message corresponding to the rotation to the one or more employees. The method allows the ESM application to send the communication message corresponding to the rotation to the one or more employees. At step 1506, the method includes allowing the first employee 102 of the one or more employees to bid for the work shift to avoid being called on for the work shift via the employee user interface based on the communication message, wherein the bid comprises a bid credit value, wherein the bid credit value is a part of the credit wallet balance. The method allows the ESM application to provide the employee user interface which allows the first employee 102 of the one or more employees to bid for the work shift to avoid being called on for the work shift.

At step 1508, the method includes receiving the bid for the work shift from the first employee 102. The method allows the ESM application to receive the bid for the work shift from the first employee 102. At step 1510, the method includes allowing the second employee 122 of the one or more employees to sign up via the employee user interface to take the bid work shift before auto-allocation. The method allows the ESM application to allow the second employee 122 of the one or more employees to sign up via the employee user interface to take the bid work shift before auto-allocation.

At step 1512, the method includes determining whether the second employee 122 or the one or more employees has self-assigned the bid work shift before auto-allocation. The method allows the ESM application to determine whether the second employee 122 or the one or more employees has self-assigned the bid work shift before auto-allocation. If it is determined, at step 1514, that the second employee 122 has self-assigned the bid work shift, at step 1516, the method includes assigning the work shift to the second employee 122. The method allows the ESM application to assign the work shift to the second employee 122. If it is determined, at step 1514, that no self-assignment occurs, at step 1518, the method includes auto assigning the bid work shift to the one or more employees based on the auto-allocation technique. The method allows the ESM application to auto assign the bid work shift to the one or more employees based on the auto-allocation technique.

At step 1520, the method includes rescheduling the work shifts of the first employee 102, and the second employee 122 or the employee assigned with the auto allocated bid work shift. The method allows the ESM application to reschedule the work shifts of the first employee 102, and the second employee 122 or the employee assigned with the auto allocated bid work shift. At step 1522, the method includes adjusting the credit wallet balance of the first employee 102, and the second employee 122 or the employee assigned with the auto allocated bid work shift. The method allows the ESM application to adjust the credit wallet balance of the first employee 102, and the second employee 122 or the employee assigned with the auto allocated bid work shift.

The various actions, acts, blocks, steps, or the like in the flow diagram may be performed in the order presented, in a different order, or simultaneously. Further, in some embodiments, some of the actions, acts, blocks, steps, or the like may be omitted, added, modified, skipped, or the like without departing from the scope of the invention.

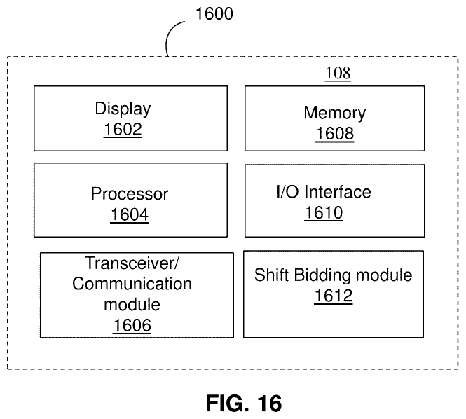

FIG. 16 is a block diagram illustrating the computing device 1600 that hosts the employee shift management (ESM) application, according to an exemplary embodiment of the present invention. In accordance with an example implementation, as shown in FIG. 16, the system 1600 may include at least a processor 1604, a memory 1608, a transceiver or communication module 1606, one or more I/O interfaces, such as an I/O interface 1610, a shift bidding module 1612, and a display 1602.

The processor 1604 may be communicably coupled with the transceiver/communication module 1606 to receive the employee data from the one or more data stores, for example data store 110. Further, the transceiver 1606 may be configured to receive the bid value and user selection data for the work shifts and transmit the communication message to one or more employee as well the manager 112. The processor 1604 is in communication with the memory 1608, configured in the form of routines, programs, objects, components, data structures and the like, which perform particular tasks to be executed by the processor 1608. The system 1600 may be connected to other information processing devices by using the I/O interface 1610. The I/O interfaces 1610 may include a variety of software and hardware interfaces, for instance, interface for peripheral device(s) such as a keyboard, a mouse, a scanner, an external memory, a printer and the like. In an embodiment, the processor 1604 may include different types of processors known in the art including neural network-based algorithms that are effectively used in several applications.

Further, the shift bidding module 1612 is configured to receive bidding from the one or more employees. Further, the shift bidding module 1612 matches the bidding value received from the one or more employees that bid for the work shift to avoid being called on for the work shift with the bidding value received from the the one or more employees that bid for obtaining the work shift. Based on the matching, the one or more employees are selected to take the shift.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

Although particular embodiments of the invention have been described in detail for purposes of illustration, various modifications and enhancements may be made without departing from the spirit and scope of the invention.

What is claimed is:

1. A method, comprising:
creating a rotation by a manager via an admin user interface, wherein the rotation comprises one or more employees as a part of a staff group, work shifts, and a rotation period, wherein each employee of the one or more employees is assigned a predefined shift work credit value and the predefined shift work credit value is added to a corresponding credit wallet balance associated with each employee of the one or more employees;
allowing a first employee of the one or more employees to bid for avoiding a work shift via an employee user interface, wherein the bid comprises a bid credit value, wherein the bid credit value is a part of the credit wallet balance;
receiving the bid for avoiding the work shift from the first employee and the one or more employees;
allowing a second employee of the one or more employees to sign up via the employee user interface to take the bid work shift before auto-allocation;
determining whether the second employee or the one or more employees self-assign the bid work shift before auto-allocation;
assigning the bid work shift to the second employee if the second employee self-assigned the bid work shift; or auto assigning the bid work shift to the one or more employees based on an auto-allocation technique if no self-assignment occurs;
rescheduling the work shifts of the first employee, the second employee or the employee assigned with the auto allocated bid work shift; and
adjusting the credit wallet balance of the first employee, and the second employee or the employee assigned with the auto allocated bid work shift.

2. The method of claim 1, further comprising sending a communication message to the one or more employee on creation of the rotation.

3. The method of claim 2, wherein the communication message comprises at least an email, a short message service (SMS), a push message, or a text message.

4. The method of claim 2, further allowing the one or more employee to open the employee user interface via a hyperlink in the communication message.

5. The method of claim 1, wherein the predefined shift work credit value is the same for all the employees.

6. The method of claim 1, wherein the predefined shift work credit value is customizable by the manager.

7. The method of claim 1, wherein the second employee or the employee assigned with the auto allocated bid work shift receives the bid credit value from the first employee and the one or more employees, and a default credit value from each of the one or more employee of the staff group for a bid work shift assignment.

8. The method of claim 1, wherein adjusting the credit wallet balance of the first employee comprising reducing the credit wallet balance of the first employee, wherein reduction value comprises a combination of the bid credit value of the first employee and the default credit value deducted from each of the one or more employees of the staff group for the bid work shift assignment.

9. The method of claim 1, wherein adjusting the credit wallet balance of the second employee or the employee assigned with the auto-allocated bid work shift comprising increasing the credit wallet balance of the second employee or the employee assigned with the auto allocated bid work shift, wherein increment value comprises a combination of the bid credit value of the first employee, and the one or more employees and the default credit value deducted from each of the one or more employee of the staff group for the bid work shift assignment.

10. The method of claim 1, further comprising initiating an automatic shift allocation by the manager for a first time via the admin user interface after a threshold period lesser than the rotation period.

11. The method of claim 1, wherein the auto-allocation technique is based on an algorithm that selects the employee with the lowest score for credit wallet balance+bid credit value * Number of employees in the staff group/2.

12. The method of claim 1, further comprising initiating a bidding process automatically in an emergency situation using the credit wallet balance of all the employees of the staff group, wherein the emergency situation comprises an employee is removed from the rotation, a block period is added for the one or more employees, an employee left an organization.

13. The method of claim 12, further comprising offering more credit value for assigning the shift in the communication messages to one or more employees.

14. The method of claim 1, further comprising allowing exchange of a shift between two employees.

15. A system, comprising:
a memory;
a processor, coupled to the memory, configured to:
create a rotation by a manager via an admin user interface, wherein the rotation comprises one or more employees as a part of a staff group, work shifts, and a rotation period, wherein each employee of the one or more employees is assigned a predefined shift work credit value and the predefined shift work credit value is added to a corresponding credit wallet balance associated with each employee of the one or more employees, wherein total credit for the staff group remains constant;
allow a first employee of the one or more employees to bid for avoiding a work shift via an employee user interface, wherein the bid comprises a bid credit value, wherein the bid credit value is a part of the credit wallet balance;
receive the bid for avoiding the work shift from the first employee and the one or more employees;
allow a second employee of the one or more employees to sign up via the employee user interface to take the bid work shift before auto-allocation;
determine whether the second employee or the one or more employees self-assign the bid work shift before auto-allocation;
assign the bid work shift to the second employee if the second employee self-assigned the bid work shift; or auto assigning the bid work shift to the one or more employees based on an auto-allocation technique if no self-assignment occurs;
reschedule the work shifts of the first employee, and the second employee or the employee assigned with the auto allocated bid work shift; and
adjust the credit wallet balance of the first employee, and the second employee or the employee assigned with the auto allocated bid work shift.

16. The system of claim 15, wherein the second employee or the employee assigned with the auto allocated bid work shift receives the bid credit value from the first employee and the one or more employees, and a default credit value from each of the one or more employee of the staff group for a bid work shift assignment.

17. The system of claim 15, wherein adjustment of the credit wallet balance of the first employee comprising reducing the credit wallet balance of the first employee, wherein reduction value comprises a combination of the bid credit value of the first employee and the default credit value deducted from each of the one or more employees of the staff group for the bid work shift assignment.

18. The system of claim 15, wherein adjustment of the credit wallet balance of the second employee or the employee assigned with the auto-allocated bid work shift comprising increasing the credit wallet balance of the second employee or the employee assigned with the auto allocated bid work shift, wherein increment value comprises a combination of the bid credit value of the first employee, and the one or more employees and the default credit value deducted from each of the one or more employee of the staff group for the bid work shift assignment.

19. The system of claim 15, wherein the auto-allocation technique is based on an algorithm that selects the employee with the lowest score for credit wallet balance+bid credit value * Number of employees in the staff group/2.

20. The system of claim 15, wherein the processor is further configured to initiate a bidding process automatically in an emergency situation using the credit wallet balance of all the employees of the staff group, wherein the emergency situation comprises an employee is removed from the rotation, a block period is added for the one or more employees, an employee left an organization.

21. The system of claim 15, wherein the processor is further configured to allow exchange of a shift between two employees.
